(19) United States
(12) Patent Application Publication
(10) Pub. No.: US 2017/0181048 A1
(43) Pub. Date: Jun. 22, 2017

(54) APPARATUS AND METHOD FOR MANAGING CALL CONTINUITY AT USER EQUIPMENT

(71) Applicant: Samsung Electronics Co., Ltd., Gyeonggi-do (KR)

(72) Inventors: Nitesh Pushpak SHAH, Bangalore (IN); Ganesh Babu KAMMA, Bangalore (IN); Shrinath Ramamoorthy MADHURANTAKAM, Bangalore (IN)

(73) Assignee: Samsung Electronics Co., Ltd.

(21) Appl. No.: 15/211,628

(22) Filed: Jul. 15, 2016

(30) Foreign Application Priority Data
Dec. 22, 2015 (IN) 6836/CHE/2015(CS)

(51) Int. Cl. H04W 36/14; H04L 29/06

(52) U.S. Cl. CPC H04W 36/14; H04L 65/1083; H04L 65/1006; H04L 65/1016; H04L 65/608

(57) ABSTRACT

An apparatus and method are provided for managing call continuity at a user equipment (UE). The method includes initiating, by the UE, a timer, when a call is active; detecting, by the UE, that the timer exceeds a timeout threshold; and sending, by the UE, to a network entity, a message for triggering a handover procedure before the timer expires, in response to detecting that the timer exceeds the timeout threshold.

### PRIORITY

This application claims priority under 35 U.S.C. §119(a) to Indian Complete Patent Application Serial No. 6836/CHE/2015 (CS), which was filed in the Indian Intellectual Property Office on Dec. 22, 2015, the entire disclosure of each of which is incorporated herein by reference.

### BACKGROUND

1. Field of the Disclosure

The present disclosure relates generally to a communication system, and more particularly, to an apparatus and method for managing call continuity at a user equipment (UE).

2. Description of Related Art

The Long Term Evolution (LTE) standard network is being co-deployed in overlapping regions with legacy cellular networks so that the UE may transition between cellular radio access technologies (RATs) when moving in and out of LTE coverage areas.

FIG. 1 is a signal flow diagram illustrating a conventional VoLTE call drop scenario.

Referring to FIG. 1, in the LTE network, a UE 102 can support a Voice over LTE (VoLTE) call while connected to a network entity 104.

In step 105, during the VoLTE call, downlink (DL) packets are at times lost before reaching a Real-time Transport Protocol (RTP) layer/RTP Control Protocol (RTCP) in the UE. For example, packet loss might occur due to high block error rate (BLER), L2TX Retransmission and L2RX Discards, a poor carrier to interference-plus-noise ratio (CINR) Ratio, Robust Header Compression (RoHC) state mismatch between the UE and an eNodeB, a RoHC decompression error, intra and inter-eNodeB handover (HO) failure, etc.

The UE starts an RTP/RTCP timer to monitor a DL Internet Protocol (IP) Multimedia Subsystem (IMS) voice/video packet reception and the RTP/RTCP timer is restarted every time a new DL VoLTE packet is received. If the RTP/RTCP timer expires in step 110, a BYE message is triggered from the UE, which results in dropping the VoLTE call in the network in step 115.

Thus, a useful alternative is desired to prevent the VoLTE call drop and improve user experience.

### SUMMARY

Accordingly, an aspect of the present disclosure is to provide an apparatus and method for managing call continuity at a UE.

Another aspect of the present disclosure is to provide an apparatus and method for detecting that an RTP/RTCP timer exceeds a timeout threshold.

Another aspect of the present disclosure is to provide an apparatus and method for sending a measurement report message to a network entity to trigger a handover procedure before an RTP/RTCP timer expires, where the measurement report includes a remaining time period before the RTP/RTCP timer expires.

Another aspect of the present disclosure is to provide an apparatus and method for sending a session initiation protocol (SIP) UPDATE message to a network entity to trigger a handover procedure before an RTP/RTCP timer expires, where the SIP UPDATE message includes a remaining time period before the RTP/RTCP timer expires.

Another aspect of the present disclosure is to provide an apparatus and method for sending a SIP INFO message to a network entity to trigger a handover procedure before an RTP/RTCP timer expires, where the SIP INFO message includes a remaining time period before the RTP/RTCP timer expires.

Another aspect of the present disclosure is to provide an apparatus and method for selecting a target cell based on a remaining timer value in a received message.

In accordance with an aspect of the present disclosure, a method is provided for managing call continuity at a UE. The method includes initiating, by the UE, a timer, when a call is active; detecting, by the UE, that the timer exceeds a timeout threshold; and sending, by the UE, to a network entity, a message for triggering a handover procedure before the timer expires, in response to detecting that the timer exceeds the timeout threshold.

In accordance with another aspect of the present disclosure, a method by a network entity for managing call continuity at a UE is provided. The method includes receiving, by the network entity, a message from the UE in an active call, wherein the message indicates a remaining time period until a timer expires at the UE; and triggering, by the network entity, a handover procedure for the active call before the timer expires, in response to receiving the message.

In accordance with another aspect of the present disclosure, a UE is provided for managing call continuity. The UE includes a transceiver configured to conduct a call through a network entity; and a processor configured to initiate a timer, when the call is active; detect that the timer exceeds a timeout threshold; and send, to the network entity, a message for triggering a handover procedure before the timer expires, in response to detecting that the timer exceeds the timeout threshold.

In accordance with another aspect of the present disclosure, a network entity is provided for managing call continuity at a UE. The network entity includes a transceiver for transmitting and receiving signals from the UE; and a processor configured to receive, from the UE in an active call, a message indicating a remaining time period until a timer expires at the UE; and trigger a handover procedure for the active call, before the timer expires at the UE, in response to receiving the message.

### BRIEF DESCRIPTION OF THE DRAWINGS

The above and other aspects, features, and advantages of certain embodiments of the present disclosure will be more apparent from the following detailed description taken in conjunction with the accompanying drawings, in which:

FIG. 1 is a signal flow diagram illustrating a conventional VoLTE call drop scenario;

FIG. 2 is a signal flow diagram illustrating a VoLTE call continuity scenario, according to an embodiment of the present disclosure;

FIG. 3 illustrates a UE, according to an embodiment of the present disclosure;

FIG. 4 illustrates a network entity, according to an embodiment of the present disclosure;

FIG. 5 is a flow diagram illustrating a method for managing call continuity at a UE, according to an embodiment of the present disclosure;

FIG. 6 is a signal flow diagram illustrating a measurement report based handover scenario for managing call continuity at a UE, according to an embodiment of the present disclosure;

FIG. 7 is a signal flow diagram illustrating a SIP UPDATE message based handover scenario for managing call continuity at a UE, according to an embodiment of the present disclosure;

FIG. 8 is a signal flow diagram illustrating a SIP INFO message based handover scenario for managing call continuity at a UE, according to an embodiment of the present disclosure;

FIG. 9 is a signal flow diagram illustrating network side operations during a handover for managing call continuity at a UE, according to an embodiment of the present disclosure; and

FIG. 10 illustrates a computing environment for managing call continuity at a UE, according to an embodiment of the present disclosure.

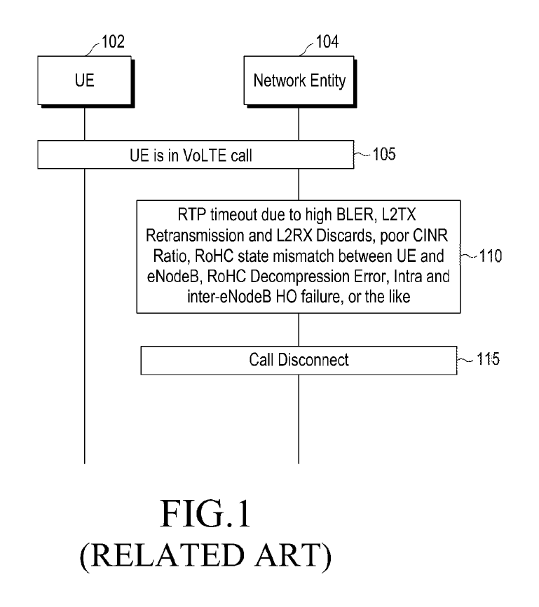

### DETAILED DESCRIPTION OF EMBODIMENTS OF THE DISCLOSURE

Various embodiments of the present disclosure will now be described in detail with reference to the accompanying drawings. In the following description, specific details such as detailed configuration and components are merely provided to assist the overall understanding of these embodiments of the present disclosure. Therefore, those skilled in the art will appreciate that various changes and modifications of the embodiments described herein can be made without departing from the scope and spirit of the present disclosure. In addition, descriptions of well-known functions and constructions are omitted for clarity and conciseness.

Also, the various embodiments described herein are not necessarily mutually exclusive, as some embodiments can be combined with one or more other embodiments to form new embodiments.

The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

The term “or” as used herein, refers to a non-exclusive or, unless otherwise indicated.

In accordance with an aspect of the present disclosure, an apparatus and method are provided for managing call continuity at a UE.

For example, the UE may be a cellular phone, a tablet, a smart phone, a laptop, a personal digital assistant (PDA), a satellite radio, a global positioning system, a multimedia device, a video device, a game console, etc. The UE may also be referred to as a mobile station, a subscriber station, a mobile unit, a subscriber unit, a wireless unit, a remote unit, a mobile device, a wireless device, a wireless communications device, a mobile subscriber station, an access terminal, a mobile terminal, a wireless terminal, a remote terminal, a handset, a user agent, a mobile client, etc.

The UE is compliant with different communication protocols and can operate as a multi-mode device by communicating within a fourth generation (4G) network employing any common type of LTE or LTE-Advanced (LTE-A) radio access technology (RAT), as well as within a third generation (3G) or second generation (2G) network employing any common type of legacy RAT.

A method includes initiating an RTP/RTCP timer to monitor the DL VoLTE packet reception, when the call is active; detecting that the RTP/RTCP timer exceeds an RTP/RTCP timeout threshold; and sending a message, to a network entity, to trigger a handover procedure before the RTP/RTCP timer expires.

For example, the message may include at least one of a remaining time period until the RTP/RTCP timer expires, a measurement report message, a SIP UPDATE message, and a SIP INFO message.

Examples of the call include an IMS voice call over an LTE network, an IMS video call over an LTE network, an IMS emergency call over an LTE network, an IMS voice call over a High Speed Packet Access (HSPA) network, an IMS video call over an HSPA network, or is an IMS emergency call over an HSPA network.

Further, the RTP/RTCP timeout threshold may be defined by an IMS of the UE, or by the network entity.

The RTP/RTCP timer is used to monitor a downlink voice or video data packet reception at the UE.

The network entity may select a target cell based on the message received from a source cell. The message for the target cell may be configured based on the remaining time period before the RTP/RTCP timer expires at the UE.

Herein, the network entity may include an eNodeB (eNB), an IP Multimedia Subsystem server, and/or a Mobility Management Entity (MME). The network entity may also be referred to as a base station, a base transceiver station, a radio base station, a radio transceiver, a transceiver function, a basic service set (BSS), an extended service set (ESS), etc.

The UE may include an IP Multimedia Subsystem that initiates an RTP/RTCP for monitoring a DL packet reception timer, when the call is active. The IP Multimedia Subsystem may be configured to detect that the RTP/RTCP timer exceeds an RTP/RTCP timeout threshold.

To continue the call, a radio resource control (RRC) unit may be configured to send a message to a network entity to trigger a handover procedure before the RTP/RTCP timer expires.

The network entity may include a processor configured to receive a message, when a call is active at the UE. However, unlike the conventional systems and methods, the message includes a time period before the RTP/RTCP timer expires at the UE. To continue the call at the UE, the processor may be further configured to trigger a handover procedure before the RTP/RTCP timer expires.

Unlike the conventional systems and methods, an RTP/RTCP layer according to an embodiment of the present disclosure can indicate the RTP/RTCP timer status to an LTE RRC layer triggering the UE to send the measurement report to the network with RTP/RTCP timeout indication/value. Based on the RTP/RTCP timeout indication/value, the network can trigger an intra-LTE handover (HO) or a single radio voice call continuity (SRVCC) HO to a 3G/2G network.

In conventional systems and methods, measurements reported by the RRC layer are generally based on physical layer measurements. The RRC layer does not distinguish between a VoLTE call and a file transfer protocol (FTP) session. However, because the VoLTE call has more sensitive quality of service (QOS) requirements than the FTP, this often results in VoLTE call dropping. Unlike these conventional systems and methods, a method according to an embodiment of the present disclosure sends a measurement report to a network in order to trigger a handover procedure before the RTP/RTCP timer expires. This improves VoLTE call continuity and enhances a user experience.

For example, the RTP/RTCP layer indicates the RTP/RTCP timer status to an IMS-application processor (AP) server, which in turn may initiate an intra-LTE HO or an SRVCC to a 2G/3G network, so that the call can successfully continue in the 2G or 3G network.

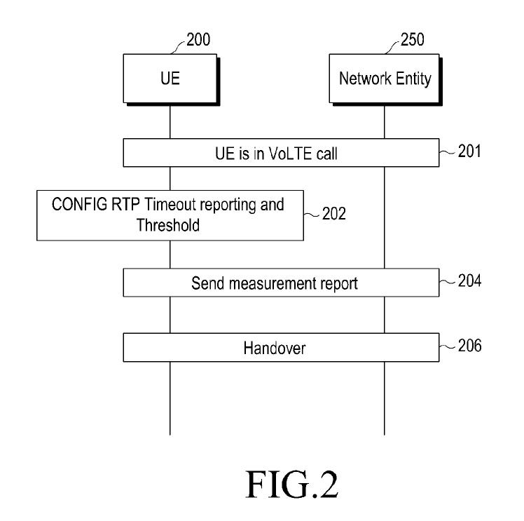

FIG. 2 is a signal flow diagram illustrating a VoLTE call continuity scenario in a UE, according to an embodiment of the present disclosure. Referring to FIG. 2, in step 201, an active VoLTE call is performed by a UE 200 and a network entity 250.

In step 202, the UE 200 does not receive DL packets from the network entity 250, e.g., due to high BLER, L2TX Retransmission and L2RX Discards, a poor CINR Ratio, an RoHC state mismatch between the UE 200 and the network entity 250, an RoHC Decompression Error, an Intra and inter-eNodeB HO failure, etc., and configures an RTP/RTCP timeout reporting and threshold level.

The RTP/RTCP timer is used to monitor DL packet reception at the UE 200.

Accordingly, the UE 200 is configured to configure the RTP/RTCP timeout reporting and threshold level and to initiate the RTP/RTCP timer. Further, the UE 200 is configured to detect that the RTP/RTCP timer exceeds a RTP timeout threshold. For example, the RTP timeout threshold may be defined by an IMS of the UE 200 or by the network entity 250.

In step 204, the UE 200 sends a message to the network entity 250 in order to trigger a handover procedure in step 206, before the RTP timer expires. The message includes a remaining time period until the RTP/RTCP timer expires. For example, the message may be a measurement report message, a SIP UPDATE message, or a SIP INFO message.

The handover procedure in step 206 may be an intra LTE handover or an SRVCC handover to a 2G or 3G network. The SRVCC provides an interim solution for handing over the VoLTE call to the 2G or 3G network. The voice calls on the LTE network are meant to be packet switched calls, which use IMS systems.

The network entity 250 may transfer the call from a source cell to a target cell during the handover procedure.

For example, the source cell may be located within the LTE network, the LTE-A network, or the HSPA network, which can support packet switched (PS) data transmission for the call, including PS video data transmission and voice over Internet Protocol (VoIP) transmission and/or other PS techniques for transmission of audio data for the voice or video call. However, the source cell is not limited to these types of networks and may be implemented in other existing and/or future-developed cellular networking technology, such as various fifth generation (5G) and beyond cellular networking technologies, which are capable of supporting PS data transmission of both video and audio data for a voice or video call.

The target cell may be located within the LTE network, the LTE-A network, or the HSPA network. The target cell may also located within a legacy cellular network having a circuit switched (CS) domain. For example, the legacy cellular network may be a third generation (3G) network, such as a Wideband Code Division Multiple Access (WCDMA) network, a Universal Mobile Telecommunications System (UMTS) network, such as a Time Division Synchronous Code Division Multiple Access (TD-SCDMA) network, a CDMA2000 network, such as a 1×RTT network, or another network standardized by the Third Generation Partnership Project 2 (3GPP2) that supports a CS domain. The legacy cellular network may also be a second generation (2G) network such as a Global System for Mobile Communications (GSM) network.

The network entity 250 may select the target cell based on the message received from the source cell. The message for the target cell is configured based on the remaining time period until the RTP timer expires at the UE 200.

If no measurement reports are available and/or the time does not permit waiting, the network entity 250 may trigger blind handover.

In an example based on the scenario illustrated in FIG. 2, the UE 200 is actively engaged in the VoLTE call within a source cell that is densely populated with a 4G LTE network. At a certain instance, the UE 200 may identify packet loss due to poor signaling conditions.

Based on the identified packets lost, the UE 200 may initiate the RTP/RTCP timer.

Thereafter, the UE 200 may detect that the RTP/RTCP timer has not expired, but exceeds an RTP/RTCP timeout threshold. Based on this detection, in order to continue the VoLTE call within the source cell or the nearby target cell, the UE 200 may send a message to the network entity 250 in order to trigger the handover procedure, before the RTP/RTCP timer expires.

As another example based on the scenario illustrated in FIG. 2, the UE 200 is actively engaged in the VoLTE call within the source cell that is densely populated with an LTE-A network. At a certain instance, the UE 200 may identify packet loss due to High BLER. The network entity 250 reports an RTP/RTCP timeout threshold value (e.g., (0.75*RTP timeout) seconds) to the UE 200. The UE 200 configures the RTP/RTCP timeout reporting and threshold value.

Thereafter, if the UE 200 detects that the RTP/RTCP timer value exceeds the RTP/RTCP timeout threshold value set by the network entity 250, the UE 200 sends a message, i.e., a measurement report, including a measure ID and report configuration to the network entity 250.

After receiving the measurement report from the UE 200, the network entity 250 may identify a target cell for the handover procedure, and then collaborate with the target cell via an interface (e.g., X2 interface), in order to carry out the handover

As another example based on the scenario illustrated in FIG. 2, the UE 200 is actively engaged in the VoLTE call within the source cell that is densely populated within an HSPA network. At a certain instance, the UE 200 may identify packet loss due to an RoHC state mismatch between the UE 200 and the network entity 250.

Based on the identified packet loss, the UE 200 initiates an RTP/RTCP timer. The UE 200 itself identifies if the RTP/RTCP timer value crosses a threshold set by the network entity 250.

If the RTP/RTCP timer crosses the RTP/RTCP timer threshold set by the network entity 250, the UE 200 sends an SIP UPDATE message to the network entity 250 and reports the current RTP/RTCP status/value in seconds to the network entity 250.

Based on measurement reports, the network entity 250 may identify a target cell for the handover and then collaborate with the target cell via an interface (e.g., X2 interface), in order to carry out the handover.

Although FIG. 2 illustrates a limited overview of a network environment for managing call continuity, the present disclosure is not limited thereto. For example, the network illustrated in FIG. 2 may also include various other components interacting locally or remotely with the UE 200 to manage call continuity.

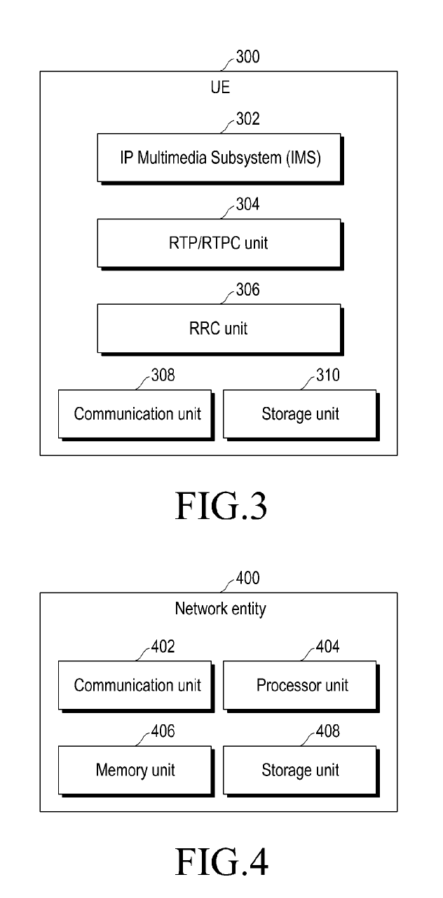

FIG. 3 illustrates a UE, according to an embodiment of the present disclosure.

Referring to FIG. 3, the UE 300 includes an IMS 302, an RTP/RTCP unit 304, an RRC unit 306, a communication unit 308, and a storage unit 310. For example, the IMS 302, the RTP/RTCP unit 304, and the RRC unit 306 may be embodied in a hardware processor of the UE 300.

The IMS 302 initiates the RTP/RTCP timer, when the call is active. For example, the IMS 302 can be an IMS stack.

The IMS 302 determines whether the current RTP/RTCP timer value call exceeds the RTP timeout threshold during the active IMS. If the RTP timer exceeds the RTP/RTCP timeout threshold, the RRC unit 306 sends a message to a network entity in order to trigger the handover procedure before the RTP/RTCP timer expires.

The communication unit 308, e.g., a transceiver, sends the handover procedure to the network entity. The communication unit 308 may communicate internally between internal units and with external devices via one or more networks.

The storage unit 310 may include one or more computer-readable storage media and/or non-volatile storage elements. Examples of the non-volatile storage elements may include magnetic hard disc, optical discs, floppy discs, flash memories, or forms of electrically programmable memories (EPROM) or electrically erasable and programmable (EEPROM) memories.

In addition, the storage unit 310 may be considered a non-transitory storage medium. Herein, the term “non-transitory” may indicate that the storage medium is not embodied in a carrier wave or a propagated signal, but should not be interpreted as meaning that the storage unit 310 is non-movable.

The storage unit 310 may be configured to store larger amounts of information than a memory.

A non-transitory storage medium may store data that can, over time, change (e.g., in Random Access Memory (RAM) or cache).

Although FIG. 3 illustrates specific components of the UE 300, the present disclosure is not limited thereto. For example, the UE 300 may include fewer or more components. Further, the labels or names of the components are used only for illustrative purpose and do not limit the scope of the disclosure. For example, one or more the components can be combined together to perform same or substantially similar function to manage the call continuity.

FIG. 4 illustrates a network entity, according to an embodiment of the present disclosure.

Referring to FIG. 4, the network entity 400 includes a communication unit 402, a processor unit 404, a memory unit 406, and a storage unit 408.

The processor unit 404 is coupled to the memory unit 408. The processor unit 304 receives a message, when the call is active at a UE. As described above, the message includes a remaining time period until the RTP/RTCP timer at the UE expires. Based on receiving the message, in order to continue the call at the UE, the processor unit 304 triggers the handover procedure before the RTP/RTCP timer expires.

The processor unit 304 transfers the call from a source cell to a target cell during the handover procedure. The processor unit 304 selects the target cell based on the message received from the source cell. The message for the target cell is configured based on the remaining time period until the RTP/RTCP timer at the UE expires.

The communication unit 402, e.g., a transceiver, may communicate internally between internal units and/or with external devices via one or more networks.

The storage unit 408 may include one or more computer-readable storage media and/or non-volatile storage elements, as described above with reference to FIG. 3.

Although FIG. 4 illustrates specific components of the network entity 400, the present disclosure is not limited thereto. For example, the network entity 400 may include fewer or more components. Further, the labels or names of the components are used only for illustrative purpose and do not limit the scope of the disclosure. For example, one or more components can be combined together to perform same or substantially similar function to manage call continuity.

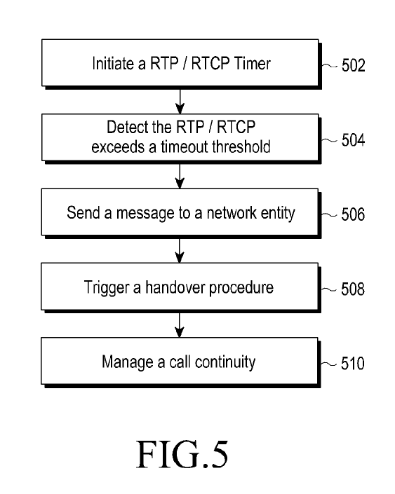

FIG. 5 is a flow diagram illustrating a method for managing call continuity at a UE, according to an embodiment of the present disclosure.

Referring to FIG. 5, in step 502, the UE initiates an RTP/RTCP timer.

In step 504, the UE detects that the RTP/RTCP timer exceeds a timeout threshold. For example, the timeout threshold may be defined by an IMS of the UE or a network entity.

In step 506, the UE sends a message to the network entity.

In step 508, the network entity triggers a handover procedure.

In step 410, the network entity manages call continuity of the UE.

Alternatively, the various actions, acts, blocks, steps, etc., as illustrated in FIG. 5, may be performed in a different order or simultaneously. Further, some of the actions, acts, blocks, steps, etc., may be omitted, added, modified, skipped, etc., without departing from the scope of the disclosure.

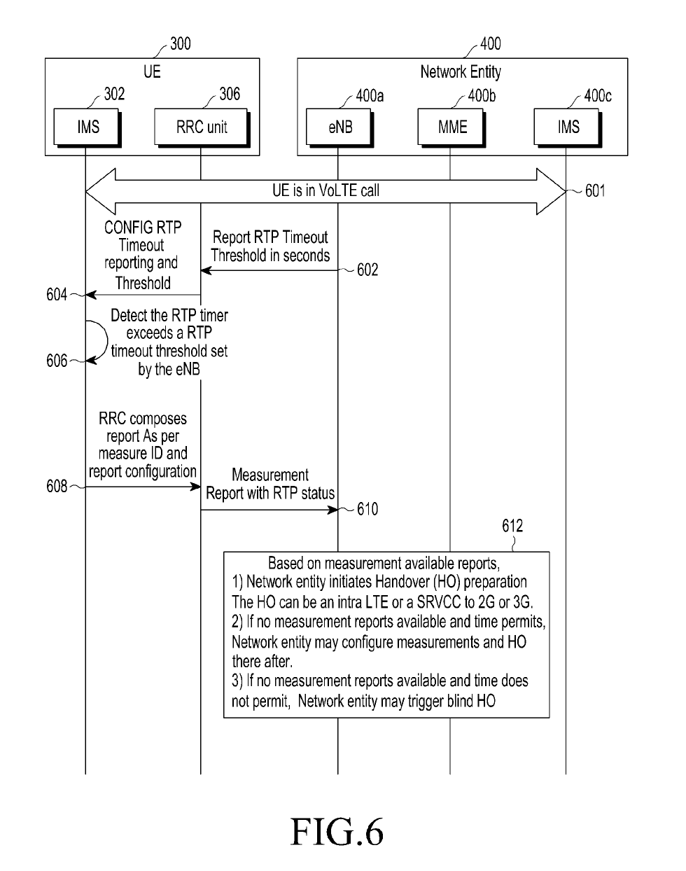

FIG. 6 is a signal flow diagram illustrating a measurement report based handover scenario for managing call continuity at a UE, according to an embodiment of the present disclosure.

Referring to FIG. 6, in step 601, the UE 300 is actively engaged in the VoLTE call.

In step 602, an eNB 400a of the network entity 400 reports an RTP/RTCP timeout threshold (e.g., in seconds) to the RRC unit 306 of the UE 300.

In step 604, the RRC unit 306 configures RTP/RTCP timeout reporting and a threshold level in the IMS 302 of the UE 300.

In step 606, the IMS 302 detects that the RTP/RTCP timer exceeds the RTP/RTCP timeout threshold.

In step 608, the IMS 302 sends a message including a measure ID and report configuration to the RRC unit 306.

In step 610, the RRC unit 306 sends a measurement report including the RTP status to the eNB 104a.

In step 612, based on measurement reports, the network entity 400 initiates HO preparation. For example, the HO can be an intra LTE HO or an SRVCC HO to a 2G or 3G network.

In step 612, if no measurement reports are available and the time permits, the network entity 400 can configure measurements and HO thereafter. However, if no measurement reports are available and time does not permit, the network entity 400 may trigger a blind HO.

For example, if the UE 300 is actively engaged in the VoLTE call within a source cell that is densely populated with a 4G LTE network, the eNB 400a may report the RTP/RTCP timeout threshold of 15 seconds to the RRC unit 310. The RRC unit 310 may configure the RTP/RTCP timeout reporting and threshold level of 15 seconds in the IMS 302.

The IMS 302 may detect that the RTP/RTCP timer value (e.g. 15 seconds) exceeds the RTP/RTCP timeout threshold value (e.g. 10 seconds) set by the eNB 104a, and send the message including the measure ID and report configuration to the RRC unit 306. The RRC unit 306 sends the measurement report including the RTP status to the eNB 104a.

Based on measurement reports, the network entity 400 initiates the HO preparation.

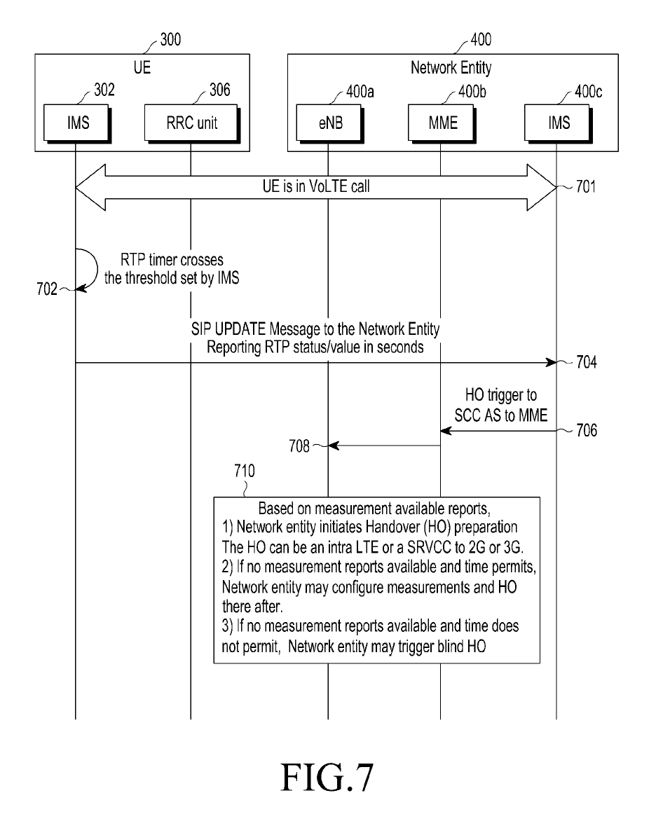

FIG. 7 is a signal flow diagram illustrating a SIP UPDATE message based handover scenario for managing call continuity at a UE, according to an embodiment of the present disclosure.

Referring to FIG. 7, in step 701, the UE 300 is actively engaged in the VoLTE call. At a certain instance, the UE 300 may identify packet loss due to poor signaling conditions. Based on the identified packet loss, the UE 300 initiates an RTP/RTCP timer.

In step 702, the IMS 302 identifies that the RTP/RTCP timer passes a threshold set by the IMS 302, and in step 704, sends a SIP UPDATE Message to the IMS 400c in the network entity 400, reporting the RTP/RTCP status/value in seconds to the IMS 400c.

In step 706, the IMS 400c triggers a handover to a service centralization and continuity application server (SCC AS) (not shown), which triggers the HO to the MME 400b.

In step 708, the MME 400b triggers the HO to the eNB 400a.

In step 710, based on measurement reports, the network entity 400 initiates the HO preparation. For example, the HO can be an intra LTE HO or an SRVCC HO to a 2G or 3G network.

In step 710, if no measurement reports are available and the time permits, the network entity 400 may configure measurements and HO thereafter. However, if no measurement reports are available and the time does not permit, the network entity 400 may trigger a blind HO.

For example, if the UE 300 is actively engaged in the VoLTE call within a source cell that is densely populated with a 4G LTE-A network, at a certain instance, the UE 300 may identify packet loss due to poor signaling conditions. Based on the identified packet loss, the UE 300 may initiate the RTP/RTCP timer.

The IMS 302 may identifies that the RTP/RTCP timer value (e.g., 15 seconds) has passed the threshold (e.g., 10 seconds) set by the IMS 302, and may send the SIP UPDATE Message to the IMS 400c, reporting the RTP/RTCP status/value in seconds to the IMS 400c.

Based on measurement reports, the network entity 400 initiates the HO preparation.

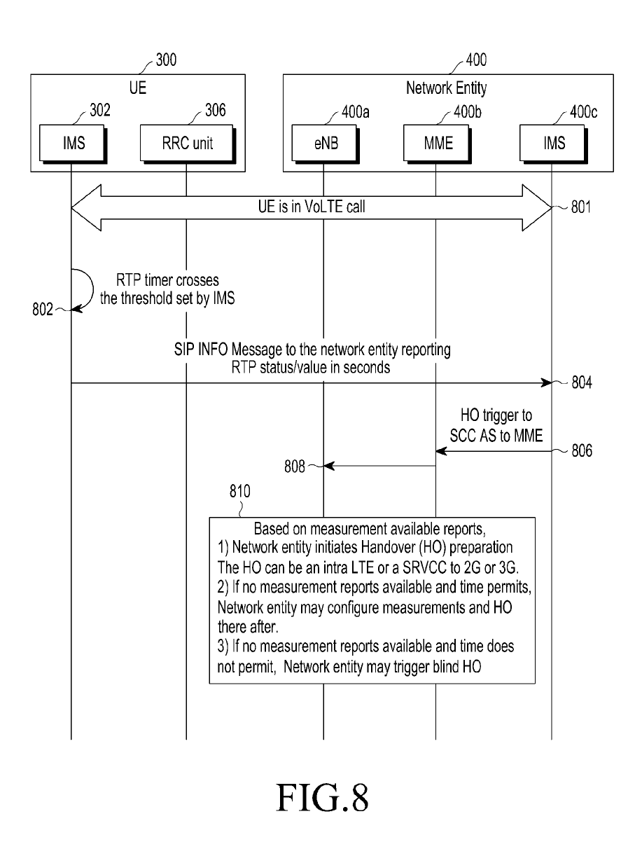

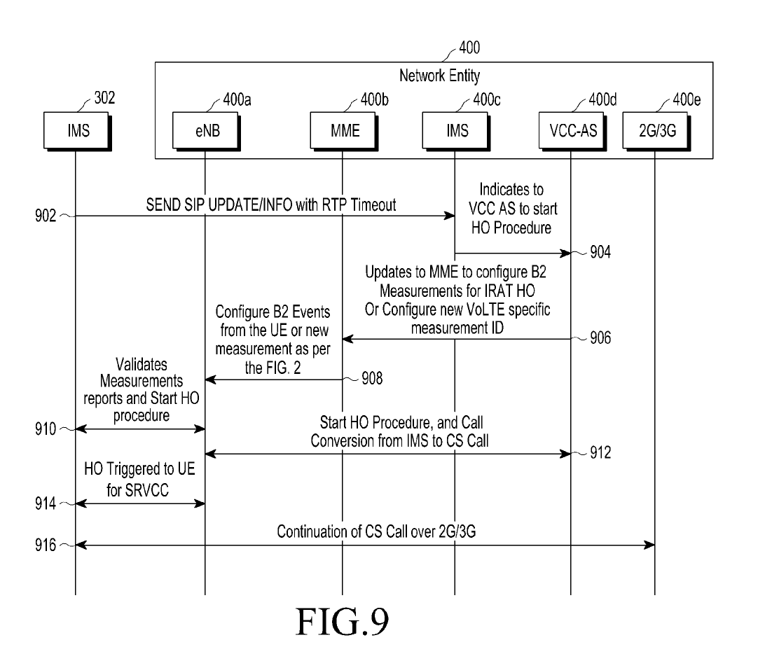

FIG. 8 is a signal flow diagram illustrating a SIP INFO message based handover scenario for managing call continuity at a UE, according to an embodiment of the present disclosure.

Referring to FIG. 8, in step 801, the UE 300 is actively engaged in the VoLTE call. At a certain instance, the UE 300 may identify packet loss due to poor signaling conditions. Based on the identified packet loss, the UE 300 initiates the RTP/RTCP timer.

In step 802, the IMS 302 identifies that the RTP/RTCP timer passes a threshold set by the IMS 302, and in step 804, sends the SIP INFO Message to the IMS 400c in the network entity 400, reporting the RTP/RTCP status/value in seconds to the IMS 400c.

In step 806, the IMS 400c triggers a HO to the SCC AS (not shown), which triggers the HO to the MME 400b.

In step 808, the MME 400b triggers the HO to the eNB 400a.

In step 810, based on measurement reports, the network entity 400 initiates the HO preparation. For example, the HO may be an intra LTE HO or an SRVCC HO to a 2G or 3G network.

In step 810, if no measurement reports are available and the time permits, the network entity 400 may configure measurements and HO thereafter. However, if no measurement reports are available and the time does not permit, the network entity 400 may trigger a blind HO.

For example, if the UE 300 is actively engaged in the VoLTE call within a source cell that is densely populated with a 4G LTE network, at a certain instance, the UE 300 may identify packet loss due to poor signaling conditions. Based on the identified packet loss, the UE 300 initiates the RTP/RTCP timer.

If the IMS 302 identifies that the RTP/RTCP timer value passes a threshold set by the IMS 302, the IMS 302 sends the SIP INFO message to the IMS 400c, reporting the current RTP/RTCP status/value in seconds to the IMS 400c.

Based on measurement reports, the network entity 400 initiates the HO preparation.

FIG. 9 is a signal flow diagram illustrating network side operations for performing a handover in order to manage call continuity at a UE, according to an embodiment of the present disclosure.

Referring to FIG. 9, in step 902, the UE 300 sends a SIP UPDATE or a SIP UPDATE INFO message including an RTP/RTCP timeout to the IMS 400c of the network entity 400.

In step 904, the IMS 400c indicates the RTP/RTCP Timeout value to a VCC AS 400d in order to start the HO procedure.

In step 906, the VCC AS 400d updates the HO procedure to the MME 400b in order to configure B2 Measurements for an inter radio access technology (IRAT) HO, or configures a new VoLTE specific measurement ID.

In step 908, the MME 400a configures B2 Events from the UE 300. Otherwise, the MME 400a may configure a new measurement as described in FIG. 2.

In step 9140, the UE 300 validates measurements reports and starts the HO procedure to the eNB 400a.

In step 912, the eNB 400a starts the HO Procedure and performs the call conversion from the IMS to the CS call.

In step 914, the UE 300 triggers the HO for the SRVCC.

In step 916, the UE 300 continues the CS Call over a 2G/3G entity 400e.

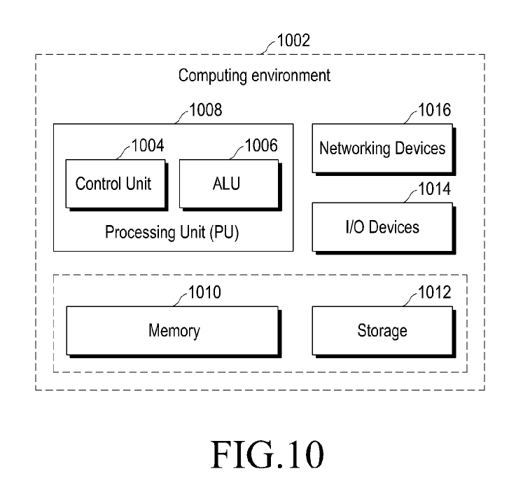

FIG. 10 illustrates a computing environment for managing call continuity at a UE, according to an embodiment of the present disclosure.

Referring to FIG. 10, the computing environment 1002 includes a processing unit 1008 that is equipped with a control unit 1004, an Arithmetic Logic Unit (ALU) 1006. The computing environment 1002 also includes a memory 1010, a storage unit 1012, a plurality of networking devices 1016, and a plurality Input output (I/O) devices 1014.

The processing unit 1008 processes instructions. The processing unit 1008 may receive commands from the control unit 1004 in order to perform processing. Further, any logical and arithmetic operations involved in the execution of the instructions may be computed with the help of the ALU 1006.

The overall computing environment 1002 may include multiple homogeneous or heterogeneous cores, multiple central processing units (CPUs) of different kinds, special media, and other accelerators. The processing unit 1008 may be included in a plurality of processing units located on a single chip or over multiple chips.

Instructions and codes for implementation are stored in the memory unit 1010 and/or the storage 1012. At the time of execution, the instructions may be fetched from the corresponding memory 1010 and/or storage 1012, and executed by the processing unit 1008.

In case of any hardware implementations, various networking devices 1016 or external I/O devices 1014 may be connected to the computing environment 1002 to support the implementation through a networking unit and an I/O device unit.

Various embodiments described herein may be implemented through at least one software program running on at least one hardware device and performing network management functions to control the elements. For example, the elements illustrated in the FIGS. 2 to 10 may include blocks, elements, actions, acts, steps, etc., which can be at least one of a hardware device, or a combination of hardware device and software module.

While the present disclosure has been particularly shown and described with reference to certain embodiments thereof, it will be understood by those of ordinary skill in the art that various changes in form and details may be made therein without departing from the spirit and scope of the present disclosure as defined by the following claims and their equivalents.

What is claimed is:

1. A method for managing call continuity at a user equipment (UE), the method comprising:
initiating, by the UE, a real-time transport protocol (RTP) timer, when a call is active;
detecting, by the UE, that the RTP timer exceeds a timeout threshold; and
sending, by the UE, to a network entity, a message for triggering a handover procedure before the RTP timer expires, in response to detecting that the timer exceeds the timeout threshold.

2. The method of claim 1, wherein the message indicates a remaining time until the RTP timer expires.

3. The method of claim 1, wherein the message includes one of a measurement report message, a session initiation protocol (SIP) UPDATE message, and a SIP INFO message.

4. The method of claim 1, wherein the call includes one of a voice call, an emergency call, an Internet protocol (IP) Multimedia Subsystem (IMS) Call, and a video call, and
wherein the call is conducted over one of a Long-Term Evolution (LTE) network and a High Speed Packet Access (HSPA) network.

5. The method of claim 1, wherein the timeout threshold is defined by one of an IP Multimedia Subsystem (IMS) of the UE and the network entity.

6. The method of claim 1, wherein the RTP timer includes an RTP control protocol timer for monitoring downlink packet reception at the UE.

7. A method by a network entity for managing call continuity at a user equipment (UE), the method comprising:
receiving, by the network entity, a message from the UE in an active call, wherein the message indicates a remaining time period until a real-time transport protocol (RTP) timer expires at the UE; and
triggering, by the network entity, a handover procedure for the active call before the RTP timer expires, in response to receiving the message.

8. The method of claim 7, further comprising transferring said the active call from a source cell to a new target cell during the handover procedure.

9. The method of claim 8, further comprising selecting, by the network entity, the target cell based on a measurement report received from the source cell, wherein the measurement report is configured based on the remaining time period until the RTP timer expires at the UE.

10. The method of claim 7, wherein the message includes one of a measurement report message, a session initiation protocol (SIP) UPDATE message, and a SIP INFO message.

11. The method of claim 7, wherein the active call includes one of a voice call, an emergency call, an Internet protocol (IP) Multimedia Subsystem (IMS) Call, and a video call, and
wherein the active call is conducted over one of a Long-Term Evolution (LTE) network and a High Speed Packet Access (HSPA) network.

12. The method of claim 7, wherein the network entity includes at least one of an eNodeB, an IP Multimedia Subsystem (IMS) server, and a mobility management entity.

13. The method of claim 7, wherein the RTP timer includes an RTP control protocol timer for monitoring downlink packet reception at the UE.

14. A user equipment (UE) for managing call continuity, the UE comprising:
a transceiver configured to conduct a call through a network entity; and
a processor configured to:
initiate a real-time transport protocol (RTP) timer, when the call is active;
detect that the RTP timer exceeds a timeout threshold; and
send, to the network entity, a message for triggering a handover procedure before the RTP timer expires, in response to detecting that the RTP timer exceeds the timeout threshold.

15. The UE of claim 14, wherein the message indicates a remaining time period until the RTP timer expires.

16. The UE of claim 14, wherein the message comprises one of a measurement report message, a Session Initiation Protocol (SIP) UPDATE message, and a SIP INFO message.

17. The UE of claim 14, wherein the call comprises one of a voice call, an emergency call, an Internet protocol (IP) Multimedia Subsystem (IMS) Call, and a video call over, and
wherein the transceiver conducts the call over one of a Long-Term Evolution (LTE) network and a High Speed Packet Access (HSPA) network.

18. The UE of claim 14, wherein the timeout threshold is defined by one of an IP Multimedia Subsystem (IMS) of the UE and the network entity.

19. The UE of claim 14, wherein the RTP timer comprises an RTP control protocol timer for monitoring downlink packet reception at the UE.

20. A network entity for managing call continuity at a user equipment (UE), the network entity comprising:
a transceiver for transmitting and receiving signals from the UE; and
a processor configured to:
receive, from the UE in an active call, a message indicating a remaining time period until a real-time transport protocol (RTP) timer expires at the UE; and
trigger a handover procedure for the active call, before the RTP timer expires at the UE, in response to receiving the message.
